(19) United States
(12) Patent Application Publication
(10) Pub. No.: US 2026/0337019 A1
(43) Pub. Date: Oct. 29, 2026

(54) PROCESSES AND METHODS FOR PRODUCING HYDROGEN AND CARBON FROM HYDROCARBONS USING HEAT CARRIER PARTICLES

(71) Applicant: Technip Energies France, Nanterre Cedex (FR)

(72) Inventors: Philip PIPER, Goleta, CA (US); Brett PARKINSON, Goleta, CA (US); Amit MAHULKAR, Goleta, CA (US); Samuel SHANER, Goleta, CA (US); Eric W. MCFARLAND, Goleta, CA (US)

(21) Appl. No.: 19/141,241

(22) PCT Filed: Dec. 21, 2023
(86) PCT No.: PCT/US2023/085476

§ 371 Date: Jun. 19, 2025

Related U.S. Application Data
(60) Provisional application No. 63/476,745, filed on Dec. 22, 2022.

(51) Int. Cl. C01B 3/26; C01B 32/05

(52) U.S. Cl. CPC C01B 3/26; C01B 32/05; C01B 2203/0277; C01B 2203/0811; C01B 2203/085; C01B 2203/1041; C01B 2203/1235

(57) ABSTRACT

A multiphase reaction process includes feeding a feed stream to a first reactor to form one or more products, entraining at least a portion of the solid carbon within a gas phase product leaving the first reactor, removing a portion of the carrier particles from the first reactor as a cold carrier stream, heating the carrier particles in the cold carrier stream in a second reactor to form a heated carrier stream, passing the heated carrier stream from the second reactor to the first reactor, and providing a heat of reaction for the conversion of the feed stream to the product in the first reactor with the heated carrier stream. The feed stream comprises a hydrocarbon, and the one or more products comprise hydrogen and solid carbon. The first reactor comprises catalyst particles and carrier particles.

### CROSS-REFERENCE TO RELATED APPLICATIONS

The present application claims priority to U.S. Provisional Application No. 63/476,745 filed on Dec. 22, 2022 and entitled, “PROCESSES AND METHODS FOR PRODUCING HYDROGEN AND CARBON FROM HYDROCARBONS USING HEAT CARRIER PARTICLES”, which is incorporated herein in its entirety.

### STATEMENT REGARDING GOVERNMENTALLY SPONSORED RESEARCH OR DEVELOPMENT

None.

### BACKGROUND

The transformation of chemical feedstocks into products relies on reactors with controlled internal conditions. Conversion of hydrocarbon feedstocks such as natural gas containing methane with strong carbon-hydrogen bonds is particularly challenging and typically utilizes reactors containing catalysts and/or making use of high temperatures. A major limitation in chemical reaction engineering is the inability to perform very high temperature reactions efficiently at high pressure due to the limitations of reactor designs. For reversible reactions, equilibrium limitations can also make very high temperatures desirable but limited by reactor designs and material considerations.

At present, industrial hydrogen is produced primarily using the steam methane reforming (SMR) process, and the product effluent from the reactors contains not only the desired hydrogen product but also other gaseous species including gaseous carbon oxides (CO/CO₂) and unconverted methane. Separation of the hydrogen for shipment or storage is carried out in a pressure swing adsorption (PSA) unit, a costly and energy-intensive separation, while the unconverted methane is often burned to heat the reformer, along with a small amount of hydrogen missed by the PSA. Generally, the carbon oxides are released to the environment. This separation process exists as an independent unit after reaction. Overall the process produces significant carbon dioxide. Natural gas is also widely used to produce power by combustion with oxygen in air, again producing significant amounts of carbon dioxide.

### SUMMARY

In some embodiments, a multiphase reaction process comprises feeding a feed stream to a first reactor to form one or more products, entraining at least a portion of the solid carbon within a gas phase product leaving the first reactor, removing a portion of the carrier particles from the first reactor as a cold carrier stream, heating the carrier particles in the cold carrier stream in a second reactor to form a heated carrier stream, passing the heated carrier stream from the second reactor to the first reactor, and providing a heat of reaction for the conversion of the feed stream to the product in the first reactor with the heated carrier stream. The feed stream comprises a hydrocarbon, and the one or more products comprise hydrogen and solid carbon. The first reactor comprises catalyst particles and carrier particles.

In some embodiments, a multiphase reaction system comprises a first reactor comprising catalyst particles and carrier particles disposed therein, and a second reactor configured to receive the colder carrier particles from the first reactor, heat the carrier particles, and pass the heated carrier particles to the first reactor. The first reactor is configured to receive a hydrocarbon feed and produce a product stream comprising hydrogen and solid carbon.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description:

FIG. 1 schematically illustrates a configuration of a multireactor system according to some embodiments.

FIG. 2 schematically illustrates particles within the system according to some embodiments.

FIG. 3 schematically illustrates another configuration of a reactor system according to some embodiments.

FIG. 4 schematically illustrates still additional configurations of reactor systems according to some embodiments.

### DETAILED DESCRIPTION

One example of an important reaction that would be favorable at very high temperatures is hydrocarbon pyrolysis. In pyrolysis of hydrocarbon reactants, the molecules are dehydrogenated, cracked and broken down into lighter hydrocarbons, olefins, aromatics, and/or solid carbon. It is generally cost effective to operate at high pressures and equilibrium restrictions favor the use of very high temperatures. A catalyst may be used as well to hasten reaction rates and improve selectivities.

Methane pyrolysis can be used as a means of producing hydrogen and solid carbon. The reaction, CH₄←→2H₂+C is limited by equilibrium such that at pressures of approximately 5-40 bar which are needed for industrial production and temperatures below 1,000 °C the methane conversion is relatively low. As a result, the introduction of heat into the reactor to maintain the reaction temperature can be useful.

The formation of the solid carbon within the reactor can also occur in a number of ways. When a media such as a molten media is used, the solid carbon can form as free particles of carbon, which can be relatively small and have a low density. The separation and removal of the carbon as well as downstream handling can be complicated by the particle size as well as potential contamination with the reaction media. The use of a substrate to allow the carbon to form on the substrate may be useful in forming carbon that is easier to handle and remove from the reactor.

Disclosed herein is a hydrocarbon pyrolysis reactor system consisting of a pyrolysis reactor containing solid particles in fluid communication with a separate solid heating vessel, whereby using a number of different methods, solid particles can be heated to pyrolysis reaction temperature and returned to the pyrolysis reactor to maintain the pyrolysis reactor at reaction temperature. Multiple types of solid particles can be used, and the relative size of the particles along with the reactor conditions can be used to control the flow and movement of the different types of particles. Hydrocarbon gases can be introduced into the pyrolysis reactor where they are decomposed into solid carbon and hydrogen. The solid carbon can deposit preferentially on the solid particles within the pyrolysis reactor and the gaseous hydrogen product can exit the reactor separate from the solid carbon.

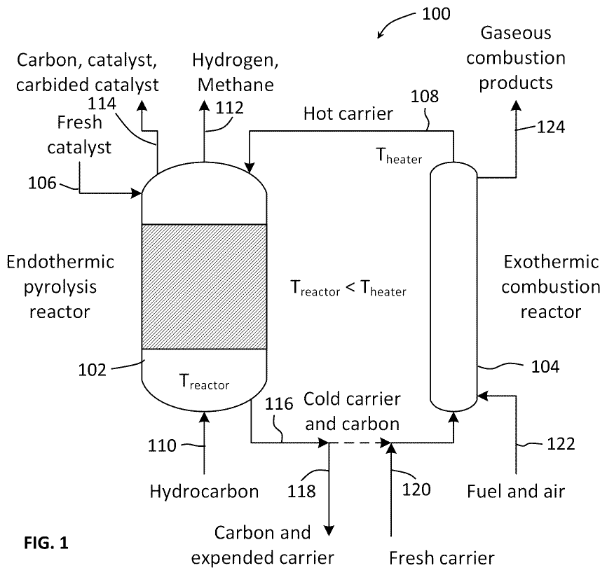

An embodiment of a reactor system 100 is illustrated in FIG. 1, which comprises a reactor 102 and a carrier heater 104. In some aspects, the reactor 102 can be used to carry out an endothermic reaction (e.g., as an endothermic reactor), and the carrier heater 104 can be used to carry out an exothermic reaction (e.g., as an exothermic reactor). As an overview, the reactor system 100 can comprise a plurality of particles including one or more catalyst particles and one or more carrier particles. In the reactor system 100, the catalyst particles can be introduced in stream 106 and the heated carrier particles can be introduced in carrier stream 108. A hydrocarbon in stream 110 can be introduced into the reactor 102. Within the reactor 102, at least a portion of the hydrocarbons can undergo a pyrolysis reaction to form solid carbon and hydrogen. The solid carbon may form on the one or more catalyst particles, while the carrier particles can be used to supply heat to the reactor 102. The resulting solid carbon on the catalyst particles can leave in stream 114 while the hydrogen and any unreacted hydrocarbons can leave in gas stream 112. In some aspects, the gas phase products and the solid carbon on the catalyst can leave as a single stream and be separated downstream of the reactor system 100.

The carrier particles can pass out of the reactor 102 as stream 116. Carbon can form on the carrier particles which may require cleaning of the particles or removal and replacement of contaminated carrier particles. The carrier particles can pass directly to the carrier heater 104 or a portion can be removed in outlet stream 118 and replaced with fresh carrier in stream 120. The carrier stream can then pass to the carrier heater 104. Fuel and air in stream 122 can be used as a combustion source to directly or indirectly heat the carrier particles within the carrier heater 104. The gas phase combustion products can leave in stream 124. The heated carrier particles can then pass as stream 108 back to the reactor 102. The heated carrier particles can have a temperature above the desired reaction temperature in the reactor 102 so that the carrier particles can be used to supply at least a portion of the heat needed for the reaction in the reactor 102.

Within the system 100, the feed stream 102 can comprise a hydrocarbon. In general, a hydrocarbon can comprise any compound comprising hydrogen and carbon, though some amount of other elements may also be present in small amounts such as nitrogen, oxygen, sulfur, or trace metals. In some aspects, the feed gas can comprise any suitable hydrocarbon, including but not limited to, light alkanes such as methane, ethane, natural gas, alkenes, alcohols, as well as other gaseous hydrocarbons, including those that can be gasified such as the gasified or pyrolyzed products of liquid, and solid hydrocarbons (e.g. crude oil, biomass, naphtha, etc.). As an example, the feed stream 102 can comprise natural gas, which can comprise primarily methane as well as minor amounts of C₂-C₄ components.

The reactor 102 can comprise one or more vessels configured to contain at least a gas phase and a solid phase to carry out a pyrolysis reaction. The reactor 102 can take a variety of forms such as a fixed bed reactor, a fluidized bed reactor, a spouting bed reactor, a moving bed reactor, a circulating fluidized bed, or the like. The carbon formation reactor 102 can operate under any conditions suitable for the conversion of at least a portion of the hydrocarbon(s) in stream 110 to hydrogen and solid carbon. In some aspects, the reaction may occur at a temperature between about 550 °C to about 1400 °C, or between about 800 °C to about 1,200 °C, or between about 850 °C and about 1,050 °C, and the reaction may occur at a pressure between about 1 and 20 bar, or between about 1 and 5 bar.

The catalyst particles can serve to catalyze the pyrolysis reaction and allow the carbon to form on the catalyst particles. This may result in the catalyst particles growing during the pyrolysis reaction within the reactor 102, or alternatively, catalyst particles may chemically disintegrate and mechanically attrit into smaller particles. In some embodiments, the catalyst can include any material suitable for catalyzing the formation of the solid carbon material from the hydrocarbon(s) in the feed stream 110. As an example, the catalyst material may be an element of Group VI, Group VII, or Group VIII of the Periodic Table of Elements (e.g., iron, nickel, molybdenum, platinum, chromium, cobalt, tungsten, vanadium, titanium, tantalum, titanium, zirconium, hafnium, etc.), an actinide, a lanthanide, oxides thereof, carbides thereof, alloys thereof, or combinations thereof. In some aspects, the catalyst may be unsupported such that the catalytic component is not placed or supported on another material. In some aspects, at least a portion of the catalyst in the catalyst particles is unsupported. For example, at least about 50% of the catalyst in the catalyst particles by weight is unsupported. In some aspects, the mass ratio of catalyst particles leaving the endothermic reactor with respect to hydrogen leaving the endothermic reactor can be between 3 and 30, or alternatively between 1 and 100.

The carrier particles can serve to transfer heat into the reactor 102 to allow the reaction to occur. The pyrolysis reaction can be endothermic such that the reactor 102 may act as an endothermic reactor for the pyrolysis reaction. The use of the carrier particles can allow heat to be introduced into the reactor 102 without the use of direct heating elements being present within the reactor 102 itself. The carrier particles can comprise any material suitable for being heated to above a reaction temperature and be present within the reactor 102 during the reaction. In some aspects, the carrier particles are different than the catalyst particles. In some aspects, the carrier particles may be formed from the same materials as the catalyst particles, where the size of the carrier particles can be the same or larger than those of the catalyst particles. When the carrier particles are formed from the same materials as the catalyst particles, the carrier particles can include any of the materials as described herein with respect to the catalyst particles.

In some aspects, the carrier particles can be different than the catalyst particles. For example, the carrier particles may be non-catalytic. In some aspects, the carrier particles can comprise species which contain magnesium, silicon, carbon, aluminum, chromium, calcium, oxygen, or some combination thereof. In some aspects, the carrier particles can comprise silica, sand, alumina, magnesia, chromia, calcia, graphite, and/or gravel. Any other suitable materials that are stable at high temperatures may also be used. In some aspects, the catalyst particles may be the same as the carrier particles such that the catalyst particles can include any of the materials as described herein with respect to the carrier particles. When the catalyst particles are the same as the carrier particles, the catalyst particles may not be catalytic. The use of the name “catalyst particle” does not preclude some aspects from using a “catalyst particle” which is non-catalytic. The nomenclature “catalyst particle” is maintained for consistency throughout the text.

The carrier particles may generally be larger than the catalyst particles. For example, the carrier particles may have a Sauter mean diameter that is larger than a Sauter mean diameter of the catalyst particles. The Sauter mean diameter may be used to represent the average diameter of an equivalent spherical particle and can be used to understand the fluidization and entrainment of the particulates. In some aspects, the catalyst particles entering the reactor 102 can have a Sauter mean diameter between about 50 and 500 μm, or between about 100 and 300 μm. The carrier particles can have a Sauter mean diameter that is at least about 1.5, at least about 2, or at least about 2.5 times as large as the Sauter mean diameter of the catalyst particles. In some embodiments, the mass ratio of carrier particles leaving the endothermic reactor with respect to hydrogen leaving the endothermic reactor can be between 100 and 1000, or alternatively between 50 and 5000.

Within the reactor 102, the hydrocarbon can undergo a pyrolysis reaction to form solid carbon. In some aspects, the solid carbon may be formed on the catalyst particles, resulting in a layer of solid carbon on the catalyst particles. Depending on the composition of the carrier particles, the solid carbon may or may not form on the carrier particles. When the carrier particles are formed from non-catalytic materials, it is expected that the amount of solid carbon formed on the carrier particles may be less than the amount of solid carbon formed on the catalyst particles.

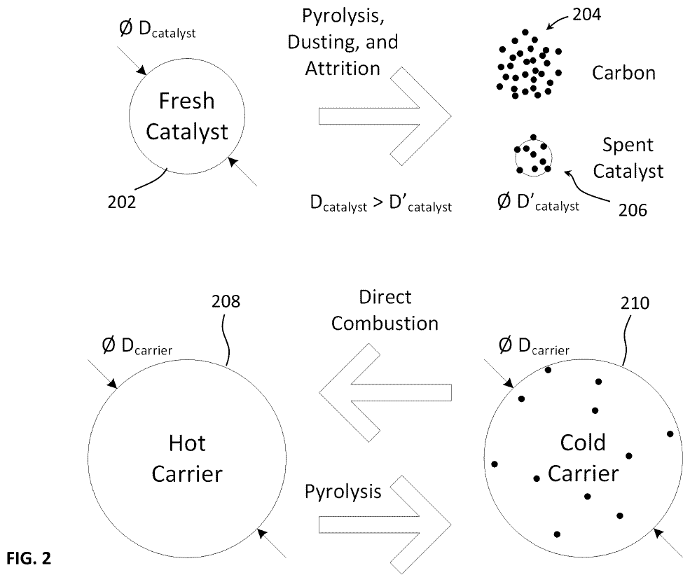

Within the reactor 102, the catalyst particles and the carrier particles can be combined and can form a mobile bed such as a fluidized bed or a spouting bed in which the particles move relative to each other. For example, at least about 20%, at least about 40%, or at least about 50% of the solid material in the reactor may be fluidized by the gas phase (e.g., the feed gas in stream 110, and the gas phase products within the reactor 102). The relative movement of the catalyst and carrier particles can cause attrition of the particles as well as the carbon formed on the catalyst particles and any formed on the carrier particles. Additionally, the particles can disintegrate by metal dusting heterogeneous chemical reactions. This process is shown schematically in FIG. 2. As illustrated, a fresh catalyst particle 202 can have an initial diameter. While shown as being round or spherical, the catalyst particle may take a variety of shapes, and collectively, the catalyst particles can have an initial average catalyst diameter, which can be expressed as an initial Sauter mean diameter. As the reaction progresses, solid carbon can be formed on the catalyst particle 202 as an outer layer while disintegrating the catalyst particle 202. As the catalyst particles 202 move relative to each other, attrition of the catalyst and the solid carbon can occur. This process is illustrated schematically with small catalyst particulates 206 and solid carbon particulates 204 being removed from the outer surface of the catalyst particle 202 through disintegration and attrition. The overall process can result in a decrease in the average diameter of the catalyst particle as demonstrated by the catalyst particle diameter being smaller for catalyst particle 206 than that of initial catalyst particle 202. As the process continues, the catalyst particle may eventually have a decreased diameter reaching a certain minimum size, at which time the catalyst particle 206 may be considered to be expended.

The carrier particles may also be present within the reactor. A fresh or new carrier particle 208 can have an initial diameter. While shown as being round or spherical, the carrier particle may take a variety of shapes. As the reaction progresses, some amount of solid carbon can be formed on the carrier particle 208 as shown schematically by carrier particle 210 having carbon formed thereon. Depending on the composition of the carrier particle 208, some amount of attrition of the carrier particle 208 and the solid carbon can occur. In some aspects, the amount of attrition, if any, of the carrier particle 208 may be relatively small, and any metal dusting reactions may be reduced or avoided through the selection of the proper materials (e.g., sand, silica, etc.). The reaction process may result in a decrease in the average diameter of the carrier particle over time, and some amount of fresh carrier particles can be introduced into the system to make up for any carrier particles removed from the system due to breakage or attrition below a certain size. As also shown schematically in FIG. 2, the hot carrier particles 208 may not have solid carbon deposited thereon when direct heat exchange is used to heat the carrier particles. The resulting exposure to the combustion gases may result in at least a portion of any solid carbon burning off of the carrier particles prior to the hot carrier particles 208 returning to the reactor, as described in more detail herein. In some aspects, all of the carrier particles contaminated with carbon may be removed from the system while fresh carrier particles are fed to be directly heated by combustion gases, thus reducing CO₂ emissions. Spent carrier particles may be used in a heat exchanger to heat fresh carrier particles.

Returning to FIG. 1, the relative size differences between the catalyst particles as disintegration and attrition occurs, the carrier particles, and the particulates of solid carbon removed from the catalyst particles can be used to selectively remove the various solid streams from the reactor 102 using the feed and product gas flow rates to fluidize and entrain portions of the particulates. The solid carbon products and catalyst particles can be removed continuously or in a semi-batch or batch process. For example, the gas velocity through the reactor could periodically be increased to remove the solid carbon particulates and/or catalyst particles at or below a certain size in a batch or semi-batch manner, or the gas flow rate could be selected along with the geometry of the reactor to have a continuously entrained stream of particulates of a desired size.

In addition to the gas phase flow rate, the density of the solid carbon, catalyst particles, and the carrier particles, and the geometry of the reactor 102 can be used to selectively remove particulates having an average diameter below a certain size from the reactor 102. In some aspects, the internal diameter of the reactor 102 can increase above the bed of particulates (e.g., the freeboard) to provide a lower gas velocity to allow larger particles to settle back to the upper surface of the bed. In some aspects, the reactor 102 can have a conical or increasing diameter towards an upper end of the reactor 102. In some aspects, the internal diameter of the reactor 102 can increase to a final diameter and then maintain the diameter to an upper end of the vessel. The shape and rate of expansion of the internal diameter can be selected to provide for a desired residence time of the solid particles entrained in the gas phase to allow proper size selection of the particles remaining in the gas phase and being removed from the reactor in stream 114.

The ability to remove the particulates can allow the solid products and a portion of the catalyst material to be removed from the carbon formation reactor based on size and density differences of the particles resulting from the disintegration via heterogeneous chemical reaction and natural attrition of the particles moving relative to each other. In some aspects, the solids entrained in the solids stream 114 can have a Sauter mean diameter that is at least about 2 times smaller than the Sauter mean diameter of the catalyst particles in the reactor 102. For example, the catalyst particles entering the reactor 102 in stream 106 can have a Sauter mean diameter between about 50 and 500 μm, or between about 100 and 300 μm. The solid phase comprising the catalyst particles, the solid carbon on the catalyst particles, and any free solid carbon within the reactor 102 can have a Sauter mean diameter between about 20 and 400 μm, or between about 50 and 250 μm. The solid carbon particles and/or solid catalyst particles resulting from chemical disintegration or attrition of the catalyst particles and solid carbon on the catalysts, can have a Sauter mean diameter between about 0.01 μm and 100 μm, or between about 0.1 μm and about 1 μm.

The relative amount of carbon removed in the solids stream 114 can be larger than the amount of catalyst removed. For example, the system and process may result in a solid phase being removed from the reactor 102 as an entrained stream, where the solid phase can include the solid carbon particles, the solid catalyst particles, and potentially a small amount of carrier particles or carrier particle material. The solid phase removed from the reactor 102 in stream 114 can be more than about 50 wt. % carbon, or greater than about 80 wt. % carbon. Within the reactor 102, the solid phase that includes the solid carbon particles, the solid catalyst particles, the solid catalyst particles having carbon formed thereon, and the carrier particles during the reaction can comprise less than about 50 wt. % carbon, less than about 30 wt. % carbon, or less than about 20 wt. % carbon.

Once removed from the reactor 102 in the solids stream 114, the entrained solids can be separated using any suitable separation device such as a cyclone, bag house, filter, or the like. The resulting solids stream from the separator can then be further processed. It is expected that some amount of the solids in the solids stream can comprise the catalytic material, and it may be useful to recycle or return at least a portion of the catalytic material into the reactor 102 to allow for further formation of the solid carbon. In order to return the solid catalyst, at least a portion of the solids leaving the reactor 102 can be separated and returned to the reactor 102 as part of stream 106 and/or as a separate solids inlet stream into the reactor 102.

Size selection can be used to provide the portion of the separated solids returned or recycled to the reactor 102. In some aspects, the portion returned to the reactor 102 can have a larger Sauter mean diameter than the rest of the solids in the product stream leaving the reactor 102. For example, the portion of the solid products returned to the reactor 102 may represent the largest 10%, the largest 20%, or the largest 30% of the solids removed from the reactor 102 as measured by the average Sauter mean diameter of the solids in the product stream. The large particles may also represent a portion of the solids having a higher mass percentage of catalyst. In some aspects, the portion of the solids stream returned or recycled to the reactor 102 can have a higher catalyst to carbon mass ratio than the rest of the solid product stream.

The gas phase products and any unreacted hydrocarbons can leave the reactor 102 as stream 112. The gas phase products can comprise the hydrogen produced in the reactor 102 as well as any unreacted hydrocarbon(s) present in the feed stream 110. The product gases can pass to a separator such as a cyclone or baghouse. Within the separator, the gas phase products can be separated from any entrained solids such as sold carbon and/or solid particles. In some aspects, the gas phase and the solid products in streams 114, 112 may pass out of the reactor 102 as a single stream and be separated in one or more downstream separators such as cyclones, baghouses, and the like. The gas phase products can then be separated using any suitable separator to produce a stream comprising a majority of the hydrogen and a stream comprising any unreacted hydrocarbons. For example, a pressure swing absorption (PSA) unit can be used to separate the hydrogen from the remaining components. The unreacted hydrocarbons can be recycled to the inlet of the reactor 102, and the stream may be compressed to the inlet pressure after the separation.

The carrier particles may be larger than the catalyst particles such that the carrier particles may accumulate in a lower portion of the reactor 102. The carrier particles can then be removed from the reactor using various types of valves to allow the carrier particles to be passed to the carrier heater 104. The carrier particle outlet to stream 116 can be positioned in a lower portion of the reactor 102 where a lower temperature can be maintained by the introduction of relatively low temperature feed gas in stream 110. The feed gas can pass counter current to the carrier particles in the reactor 102 to cool the carrier particles while heating the feed gas. In some aspects, the carrier particles can pass out of the reactor at a temperature in a range of about 600 °C to about 1200 °C, or between about 800 °C to about 1050 °C. Various techniques including pneumatic conveyance can be used to remove the relatively cool carrier particles from the reactor 102 to carrier heater 104 via pressure differential between the two vessels.

The carrier heater 104 is configured to heat the carrier particles removed from the reactor 102, thereby allowing for the heated carrier particles to be returned to the reactor 102 to provide the heat for the reaction. The carrier particles can pass through an outlet into a transfer section before passing to the carrier heater 104, which can comprise a vessel or riser for heating. Within the transfer section, all of the carrier particles can pass to the carrier heater 104, or alternatively, all of or some portion of all of the carrier particles from the reactor 102 can be removed from the system 100. When all of or a portion of the carrier particles from the reactor 102 are removed from the system 100, a makeup stream 120 of the carrier particles can be introduced upstream of the carrier heater 104. The makeup stream 120 can comprise fresh carrier particles. The carrier particles in the makeup stream 120 can be pre-heated prior to being passed to the carrier heater 104. For example, various streams such as the expended carrier stream 118, solids stream 114, the outlet gas stream 112, and/or the flue gas stream 124 may be used at least in part to heat the carrier particles in the makeup stream 120. The resulting stream of carrier particles can then pass to the carrier heater 104, for example, using any suitable conveyance system.

In some embodiments, the carrier heater 104 can comprise a vessel in fluid communication with the reactor 102 through the transfer section by way of a non-mechanical valve such as an L-valve or loop seal, which can use a gas to convey the solids such as the carrier particles in the direction of a pressure drop. This configuration can allow the carrier particles to be conveyed from the reactor 102 along the transfer section into the carrier heater 104. In some aspects, the gas used for the transfer of the carrier particles can comprise a fuel stream used as part of the carrier heater 104. In some aspects, an inert gas or combustion products may also be used as the pneumatic conveyance gas.

The carrier heater 104 can allow the carrier particles to be heated to very high temperatures using combustion or a pre-heated gas (e.g., an electrically heated gases, etc.) with direct or indirect contact with the carrier particles. Use of the carrier heater 104 in this configuration can enable a low-cost means of providing the heat of reaction in a stream of heated carrier particles returned to the reactor 102 using combustion of hydrocarbons or hydrogen in an oxygen containing gas such as air or oxygen, or by electrically heating an injected gas stream (e.g. hydrogen, an inert gas, etc.). When direct heat exchange is used, the combustion gasses can be used to pneumatically convey the carrier particles within the carrier heater 104 to an outlet of the carrier heater 104.

In some aspects, direct contact between the carrier particles and the combustion can provide an efficient manner for heating the carrier particles. Further, a non-mechanical valve can be used to separate the heated carrier particles from the resulting combustion gas for isolating any oxygen/air coming from the carrier heater 104 to prevent oxygen from entering the reactor 102. In some aspects, the carrier heater 104 can provide the mean of a short reaction time for hydrocarbon combustion, reducing or minimizing solid carbon combustion. In some aspects, the combustion time in the carrier heater 104 can be controlled to combust any carbon formed on the carrier particles, thereby allowing for the carrier particles to be returned to the reactor 102 with all or substantially all of any carbon formed on the carrier particles being removed.

In some aspects, the heating within the carrier heater 104 can be accomplished by the combustion of a gas to directly heat the carrier particles. In some aspects, one or more streams of a combustion gas can be used to convey the carrier particles within the carrier heater 104. The combustion gas can comprise any suitable gas such as a hydrocarbon (e.g., methane, natural gas, etc.), hydrogen, or other hydrocarbons such as coal, methanol, ethanol, ethane, propane, butane, gasoline, kerosene, naphtha, or combinations thereof. A source of oxygen, and optionally the combustion gas and/or additional combustion gas, can be introduced in stream 122. The oxygen source can comprise air and/or an oxygen enriched stream. An oxygen enriched stream refers to any stream having an oxygen concentration greater than the atmospheric concentration of oxygen. The oxygen stream can be obtained at a desired purity from an oxygen storage tank, or via an oxygen enrichment process, for example, the separation of air into nitrogen and oxygen, such as pressure swing adsorption (PSA), vacuum swing adsorption (VSA), or cryogenic separation techniques. The oxygen in the oxygen stream may have at least about 70 vol %, at least 80 vol %, or at least 90 vol % oxygen (e.g., 90, 91, 92, 93, 94, 95, 96, 97, 98, 99, 99.1, 99.2, 99.3, 99.4, 99.5, 99.6, 99.7, 99.8, 99.9, or 100 vol % oxygen). In some aspects, hydrogen can be used as the combustion gas in place of the hydrocarbon in the carrier heater 104. This may allow for the combustion products to comprise steam rather than a carbon oxide such as carbon dioxide. While shown as a single stream 122 entering the lower portion of the carrier heater 104, the air and/or oxygen enriched stream 122 may be introduced as two or more separate streams along the length of the carrier heater 104. The use of the carrier heater 104 provides flexibility in the means of combustion heating of the carrier particles in the riser. In some embodiments, air or oxygen enriched in a gas streams are used for combustion to reach high temperatures more efficiently in the carrier heater 104 and produce either a more purified carbon dioxide in stream 124 that can be readily sequestered if hydrocarbon combustion is used, or steam if hydrogen combustion is utilized. In some aspects, the carrier heater 104 can be arranged as a vertical vessel with the carrier particles moving from a lower to an upper portion of the vessel. In this configuration, the use of the carrier heater 104 can also provide an elevation and high-pressure differential for returning the heated carrier particles to the upper portion of the reactor 102.

The combustion gas and oxygen can combust within the carrier heater 104 to form a combustion product gas and heat. The combustion product gas products can include gas phase products such as carbon monoxide, carbon dioxide, water, and unreacted hydrocarbons. When oxygen enriched gas is used, the amount of nitrogen present may be decreased and the concentration of carbon monoxide, carbon dioxide and water may be increased. This may allow for a more concentrated carbon dioxide stream leaving the system if separation of the carbon dioxide is desired and may reduce the formation of NO and NO₂. The carrier particles can be heated to a temperature between about 800 °C and about 1400 °C in the carrier heater 104. The heated carrier particles can be between about 25 °C to about 500 °C, or about 50 °C to about 250 °C hotter than the reaction temperature within the reactor 102.

In some embodiments, the carrier heater 104 may provide indirect heating of the carrier particles. In these embodiments, a barrier can be used between the combustion gasses and the carrier particles. A carrier gas can be used to pneumatically convey the carrier particles through the carrier heater 104 when indirect heat exchange is used. The carrier gas may comprise a reaction product, inert gas, and or a feed gas to the reactor. The carrier gas may not significantly comprise oxygen to avoid the presence of oxygen within the reactor 102. When using indirect heating, the carrier gas may have no more than 22%, no more than 1%, or no more than 0.01% oxygen by mole. For example, the carrier gas may comprise hydrogen, helium, neon, a hydrocarbon (e.g., methane, natural gas, etc.), nitrogen, carbon dioxide, argon, krypton, or any combination thereof. In some aspects when indirect heat exchange is used, the carrier particles may be electrically heated within the carrier heater 104, using for example, renewable electricity.

The product stream from the carrier heater 104 can pass to a separator such as a cyclone system comprising a primary cyclone separator and one or more secondary cyclones. The separator can be used to separate the heated carrier particles from the gas phase products. The heated carrier particles can pass through a solids outlet from the carrier heater 104 to the reactor 102. When a cyclone system is used, a preheated stream comprising hydrogen can be passed through the heated carrier particles in the solids outlet from the carrier heater 104 to prevent any backflow of oxygen containing gases into the reactor 102 and convey the solids. The use of hydrogen can provide a reducing environment to react any remaining oxygen and prevent the oxygen from entering the reactor 102. In some aspects, the heated carrier particles can pass into the reactor 102 through a non-mechanical valve at 108 to carry out the reactions. In this configuration, the carrier heater 104 can serve to lift and heat the carrier particles to allow the heated carrier particles to flow by gravity and/or pneumatic conveyance back to the reactor 102 through the non-mechanical valve.

The gas phase products and/or other gases associated with heating the carrier particles in the carrier heater 104 can pass out of the separator as stream 124 for further processing and/or heat recovery. In some aspects, the gas in stream 124 can be used to preheat the feed stream 110, the carrier particle makeup stream 120, and/or the combustion gas and/or oxygen in stream 122. In some embodiments, the gas phase products in stream 124 can comprise a portion of the carrier particles that can be oxidized within the carrier heater 104. For example, between about 0% and about 10% by mass of the carrier particles can oxidize and pass out of the carrier heater 104 with the gas phase products in stream 124.

Within the reactor 102, the heated carrier particles can be used to raise and maintain the temperature of the catalytic particles to a reaction temperature. Overall, the reactor system 100 uses the circulation of a high temperature solid media from an exothermic reaction to introduce heat in a reactor that can carry out an endothermic reaction. In some aspects, the use of the carrier heater 104 and the heated carrier particles can provide at least about 40%, at least about 50%, or at least about 60% of the heat used in the endothermic reaction within the reactor 102. The mass flowrate of the carrier particles can be selected to provide the desired amount of heat into the reactor 102 to maintain the reaction temperature within the reactor 102. In some aspects, the mass flow rate of the heated carrier particles into the reactor 102 can be between about 50 and about 5000 times, or between about 100 and about 1000 times the mass production rate of hydrogen in the reactor 102.

The system described herein can be used to carry out a reaction process as described herein. In the process, a feed stream comprising a hydrocarbon can be reacted within a reactor in the presence of catalyst particles and carrier particles to form hydrogen and solid carbon. The carbon can form as a layer on the catalyst particles, and during the reaction, a portion of the solid carbon may form carbon particles due to the movement and reactions of the catalyst particles within the reactor. The gas phase products can pass out of the reactor, and the solid carbon can pass out of the reactor as a result of being entrained by the gas passing through the reactor. The reactor design and operating conditions can be selected to entrain particles of a specific size and remove the solid carbon and catalyst particles from the reactor. The carrier particles can pass out of the reactor in a lower portion without being entrained based on a size and density of the carrier particles. The carrier particles can then pass to a carrier heater where the carrier particles can be heated by direct or indirect heat exchange before returning to the reactor. The heated carrier particles can be used to heat and maintain the reactor at the reaction temperature during the reaction. The overall reaction can result in the pyrolysis of the hydrocarbons in the feed stream to produce solid carbon and hydrogen while using the carrier particles to convey heat into the reactor during the reaction. The overall process can be carried out in a manner that is substantially free from the production of carbon dioxide.

The process may operate free or substantially free of direct CO₂ emissions. For example, the only CO₂ emissions may occur due to small amounts of carbon oxidized to CO₂ and exiting the second reactor 104 in the combustion products stream 124. In some aspects, the system may operate with direct CO, CO₂, and CH₄ emissions at a level of less than 3 kg CO₂ₑ/kg H₂ produced, or alternatively at a level of less than 1 kg CO₂ₑ/kg H₂ produced.

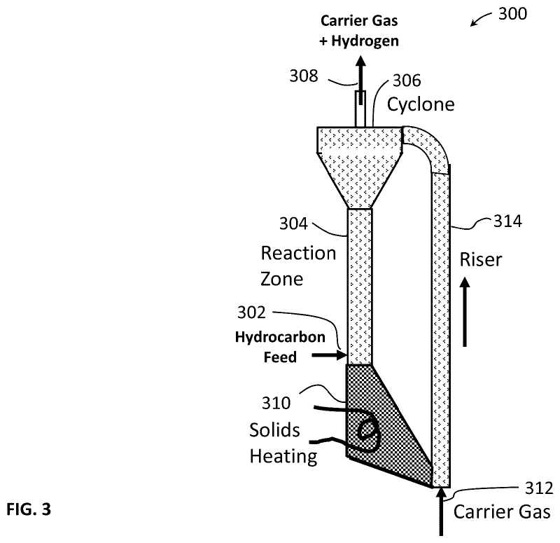

Another embodiment of a reactor system 300 is shown schematically in FIG. 3. As shown, solids can be heated in a heating section 310 that can include a refractory lined vessel. The solids can include any of the catalyst or carrier particles as described herein. The heating section 310 can heat the solids using various means including electrically (e.g., using electrical heating elements, etc.) or chemically by way of combustion gases. The solids can move under the force of gravity downward in the heating section to an entrainment region where heated solids can be contacted with a carrier gas 312 and carried upward through the riser 314 into a thermally insulated cyclone 306. Most of the hot solids can be separated from the carrier gas within the cyclone 306 and fall under the influence of gravity downward through the pyrolysis reactor section 304. The heated solids can move downward through the reaction zone 304 countercurrent to the hydrocarbon feed 302, and reaction products can move upward from their inlet at the top of the solids heating section 310 to an outlet of the cyclone 306 and leave as stream 308. The hydrocarbon feed 302 can comprise any of the hydrocarbons as described herein. The heated solids provide all the heat required for the reaction in the embodiment shown in FIG. 3. The reactor, cyclone, and vessel sections are all constructed of refractory material in contact with the heated solids and gas and solid phase reactants and products contained within metallic pressure vessels.

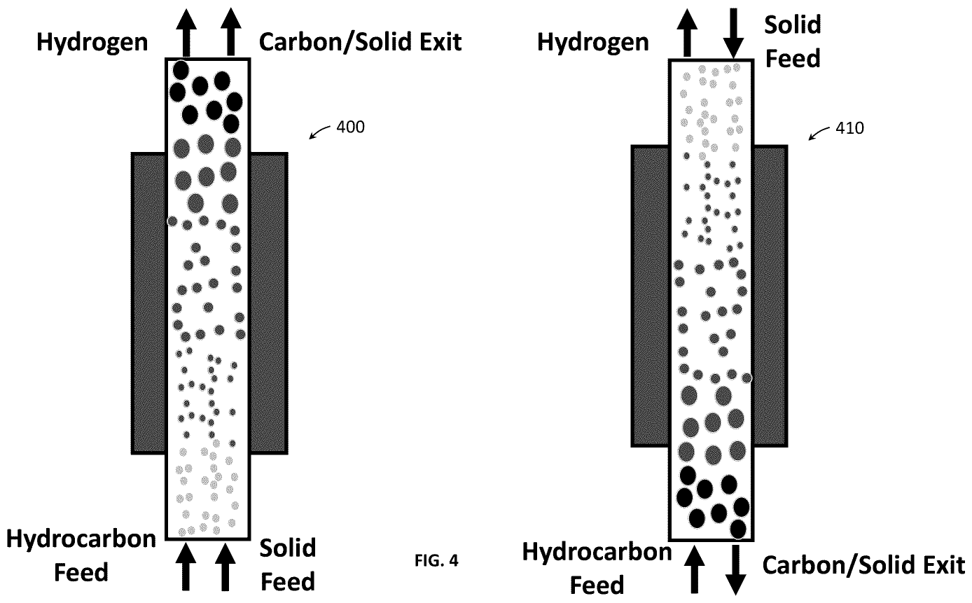

Another embodiment for hydrocarbon pyrolysis producing hydrogen and solid carbon, solids are circulated as shown in FIG. 4, or by other means and caused to pass through a tubular reaction zone whereby the tube can be heated externally. The solids can be made to move co-current 400 or counter-current 410 with respect to hydrocarbon reactant gases, as shown in FIG. 4. The solids can be the same as any of the solids disclosed herein (e.g., catalytic and/or carrier particles, etc.), and the hydrocarbon reactant gases can comprise any of the hydrocarbons as disclosed herein. The presence of the solids can serve two functions, i) to increase the heat transfer coefficient from the tube wall to the tube interior, especially when radiation heat transfer pathways are important at high temperature, and ii) to promote solids deposition from decomposition (e.g., pyrolysis) of the hydrocarbon reactant such that the majority of carbon produced by pyrolysis is deposited on the surface area of the solid particles and not on the reactor walls. Further, the contact of the moving solids with the reactor tube walls can serve to abrade (e.g., by attrition, etc.) solid residues deposited on the walls preventing accumulation. Without the solids present, tubular reactors have limited applicability for pyrolysis due to the heat transfer limitation which would restrict tubes to small diameters, and the large fraction of carbon deposition on the wall which requires frequent removal. The use of the entrained solids allows for use of larger tube diameters and minimizes the required intervals for removal of carbon deposited on the tube walls. Further, with particulates comprised of catalytic materials the reaction rate can be increased and the structure of the solid carbon product of pyrolysis altered.

Having described various systems, methods, and processes, certain aspects as disclosed herein can include, but are not limited to:

In a first aspects, a multiphase reaction process comprises feeding a feed stream to a first reactor to form one or more products, wherein the feed stream comprises a hydrocarbon, and wherein the one or more products comprise hydrogen and solid carbon, wherein the first reactor comprises catalyst particles and carrier particles; entraining at least a portion of the solid carbon within a gas phase product leaving the first reactor; removing a portion of the carrier particles from the first reactor as a cold carrier stream; heating the carrier particles in the cold carrier stream in a second reactor to form a heated carrier stream; passing the heated carrier stream from the second reactor to the first reactor; and providing a heat of reaction for the conversion of the feed stream to the product in the first reactor with the heated carrier stream.

A second aspect can include the process of the first aspect, wherein heating the cold carrier stream in the second reactor comprises: combusting a combustion gas in the second reactor to create heat, and heating the carrier particles in the cold carrier stream with the heat.

A third aspect can include the process of the second aspect, wherein heating the carrier particles with the heat comprises directly contacting combustion products produced from combusting the combustion gas with the carrier particles in the cold carrier stream.

A fourth aspect can include the process of the second or third aspect, where the second reactor produces a flue gas stream, and wherein the method further comprises: using the flue gas stream to preheat the combustion gas.

A fifth aspect can include the process of any one of the second to fourth aspects, wherein the combustion gas comprises methane or natural gas.

A sixth aspect can include the process of any one of the second to fifth aspects, wherein the combustion gas comprises hydrogen.

A seventh aspect can include the process of any one of the second to sixth aspects, wherein the combustion gas comprises coal, methanol, ethanol, ethane, propane, butane, gasoline, kerosene, or naphtha.

An eighth aspect can include the process of any one of the second to seventh aspects, wherein the combustion gas comprises oxygen.

A ninth aspect can include the process of any one of the first to eighth aspects, wherein heating the carrier particles in the second reactor comprises electrically heating the particles with resistive or inductive heating.

A tenth aspect can include the process of any one of the first to ninth aspects, wherein at least a portion of the catalyst particles are entrained within the gas phase product leaving the first reactor.

An eleventh aspect can include the process of any one of the first to tenth aspects, wherein the first reactor is an endothermic reactor, and wherein the second reactor is an exothermic reactor.

A twelfth aspect can include the process of any one of the first to eleventh aspects, further comprising: feeding additional catalyst particles into the first reactor while the catalyst particles are entrained out of the first reactor.

A thirteenth aspect can include the process of any one of the first to twelfth aspects, further comprising: separating a portion of the catalyst particles entrained in the gas phase product leaving the first reactor; and returning at least a portion of the catalyst particles separated from the gas phase product to the first reactor.

A fourteenth aspect can include the process of any one of the first to thirteenth aspects, further comprising: removing all of or a portion of the cold carrier stream from the process.

A fifteenth aspect can include the process of any one of the first to fourteenth aspects, further comprising: combining the cold carrier stream with an additional amount of the carrier particles, wherein heating the cold carrier stream in the second reactor comprises heating the additional amount of the carrier particles in the second reactor.

A sixteenth aspect can include the process of the fifteenth aspect, further comprising: preheating the additional amount of the carrier particles prior to combining the cold carrier stream with the additional amount of the carrier particles.

A seventeenth aspect can include the process of any one of the first to sixteenth aspects, wherein heating the cold carrier stream in the second reactor comprises: transporting the carrier particles in the cold carrier stream through the second reactor using a carrier gas; and indirectly heating the carrier particles in the second reactor while transporting the carrier particles through the second reactor.

An eighteenth aspect can include the process of the seventeenth aspect, wherein the carrier gas stream comprises hydrogen, helium, neon, methane, nitrogen, carbon dioxide, argon, krypton, or combinations thereof.

A nineteenth aspect can include the process of any one of the first to eighteenth aspects, wherein at least 50% of the heat of reaction for converting the feed stream to the one or more products is provided by the heated carrier stream.

A twentieth aspect can include the process of any one of the first to nineteenth aspects, wherein the heated carrier stream is between 25 and 500 °C hotter than a reaction temperature in the first reactor.

A twenty first aspect can include the process of any one of the first to twentieth aspects, wherein a reaction temperature in the first reactor is between 800 °C and 1300 °C.

A twenty second aspect can include the process of any one of the first to twenty first aspects, wherein the cold carrier stream is between 0 and 300 °C cooler than a reaction temperature in the first reactor.

A twenty third aspect can include the process of any one of the first to twenty second aspects, wherein the first reactor operates between 1 and 20 bar atmosphere.

A twenty fourth aspect can include the process of any one of the first to twenty third aspects, wherein a mass flow rate of carrier particles in the heated carrier stream flow rate is between about 50 and about 5000 times a production rate of hydrogen by mass in the first reactor.

A twenty fifth aspect can include the process of any one of the first to twenty fourth aspects, wherein the catalyst particles comprises Fe in its metallic, oxide, or carbide forms.

A twenty sixth aspect can include the process of any one of the first to twenty fifth aspects, wherein the catalyst particles comprises Ni or Co in their metallic, oxide, or carbide forms.

A twenty seventh aspect can include the process of any one of the first to twenty sixth aspects, wherein the catalyst particles comprises W, V, Mo, Ti, Ni, Ta, Zr, Cr, or Hf in their metallic, oxide, or carbide forms.

A twenty eighth aspect can include the process of any one of the first to twenty seventh aspects, wherein at least 50% of a catalyst in the catalyst particles is unsupported.

A twenty ninth aspect can include the process of any one of the first to twenty eighth aspects, wherein the carrier particles comprises magnesium, aluminum, chromium, silicon, carbon, calcium, or any combination thereof.

A thirtieth aspect can include the process of any one of the first to twenty ninth aspects, wherein the carrier particles comprise magnesia, alumina, chromia, silica, graphite, calcia, sand, gravel, or any combination thereof.

A thirty first aspect can include the process of any one of the first to thirtieth aspects, wherein the catalyst particles are formed from the same material as the carrier particles.

A thirty second aspect can include the process of any one of the first to thirty first aspects, wherein a Sauter mean diameter of the carrier particles is larger than a Sauter mean diameter of the catalyst particles in the first reactor.

A thirty third aspect can include the process of any one of the first to thirty second aspects, where the gas phase product comprises hydrogen and unreacted hydrocarbon, wherein the process further comprises: separating the gas phase product into a first stream comprising predominantly hydrogen and a second stream comprising predominantly the unreacted hydrocarbon; and recycling the second stream to an inlet of the first reactor.

A thirty fourth aspect can include the process of any one of the first to thirty third aspects, wherein the entrained solid carbon and catalyst particles have a higher carbon to catalyst mass ratio than the solid phase in the first reactor.

A thirty fifth aspect can include the process of any one of the first to thirty fourth aspects, wherein between 0% and 10% by mass of the carrier particles entering the second reactor pass out of the second reactor as an oxide.

A thirty sixth aspect can include the process of any one of the first to thirty fifth aspects, wherein the gas phase stream leaving the first reactor and a gas phase stream leaving the second reactor are substantially free of carbon dioxide.

A thirty seventh aspect can include the process of any one of the first to thirty sixth aspects, wherein between 0% and 10% of gases in the first reactor leak into the second reactor with the cold carrier stream; and between 0% and 10% of gases in the second reactor leak into the first reactor with the heated carrier stream.

In a thirty eighth aspect, a multiphase reaction system comprises a first reactor comprising catalyst particles and carrier particles disposed therein, wherein the first reactor is configured to receive a hydrocarbon feed and produce a product stream comprising hydrogen and solid carbon; and a second reactor configured to receive the colder carrier particles from the first reactor, heat the carrier particles, and pass the heated carrier particles to the first reactor.

A thirty ninth aspect can include the system of the thirty eighth aspect, wherein the second reactor comprises a direct heat exchanger configured to directly contact a combusted gas and the carrier particles.

A fortieth aspect can include the system of the thirty eighth or thirty ninth aspect, wherein the second reactor comprises an indirect heat exchanger configured to indirectly exchange heat between a heat source and the carrier particles.

A forty first aspect can include the system of any one of the thirty eighth to fortieth aspects, further comprising a separator configured to receive a gas phase product from the first reactor and separate the gas phase product into a first stream comprising hydrogen and a second stream comprising an unreacted hydrocarbon.

A forty second aspect can include the system of any one of the thirty eighth to forty first aspects, wherein the catalyst particles comprises Fe in its metallic, oxide, or carbide forms.

A forty third aspect can include the system of any one of the thirty eighth to forty second aspects, wherein the catalyst particles comprises Ni or Co in their metallic, oxide, or carbide forms.

A forty fourth aspect can include the system of any one of the thirty eighth to forty third aspects, wherein the catalyst particles comprises W, V, Mo, Ti, Ni, Ta, Zr, Cr, Hf in their metallic, oxide, or carbide forms.

A forty fifth aspect can include the system of any one of the thirty eighth to forty third aspects, wherein at least 50% of a catalyst in the catalyst particles is unsupported.

A forty sixth aspect can include the system of any one of the thirty eighth to forty fifth aspects, wherein the carrier particles comprises magnesium, aluminum, chromium, silicon, carbon, calcium, or any combination thereof.

A forty seventh aspect can include the system of any one of the thirty eighth to forty sixth aspects, wherein the carrier particles comprise magnesia, alumina, chromia, silica, graphite, calcia, sand, gravel, or any combination thereof.

A forty eighth aspect can include the system of any one of the thirty eighth to forty seventh aspects, wherein the catalyst particles are formed from the same as the carrier particles.

A forty ninth aspect can include the system of any one of the thirty eighth to forty eighth aspects, wherein a Sauter mean diameter of the carrier particles is larger than a Sauter mean diameter of the catalyst particles in the first reactor.

Embodiments are discussed herein with reference to the Figures. However, those skilled in the art will readily appreciate that the detailed description given herein with respect to these figures is for explanatory purposes as the systems and methods extend beyond these limited embodiments. For example, it should be appreciated that those skilled in the art will, in light of the teachings of the present description, recognize a multiplicity of alternate and suitable approaches, depending upon the needs of the particular application, to implement the functionality of any given detail described herein, beyond the particular implementation choices in the following embodiments described and shown. That is, there are numerous modifications and variations that are too numerous to be listed but that all fit within the scope of the present description. Also, singular words should be read as plural and vice versa and masculine as feminine and vice versa, where appropriate, and alternative embodiments do not necessarily imply that the two are mutually exclusive.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although claims may be formulated in this application or of any further application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicant(s) hereby give notice that new claims may be formulated to such features and/or combinations of such features during the prosecution of the present Application or of any further Application derived therefrom.

1. A multiphase reaction process comprising:
feeding a feed stream to a first reactor to form one or more products, wherein the feed stream comprises a hydrocarbon, and wherein the one or more products comprise hydrogen and solid carbon, wherein the first reactor comprises catalyst particles and carrier particles;
entraining at least a portion of the solid carbon within a gas phase product leaving the first reactor;
removing a portion of the carrier particles from the first reactor as a cold carrier stream;
heating the carrier particles in the cold carrier stream in a second reactor to form a heated carrier stream;
passing the heated carrier stream from the second reactor to the first reactor; and
providing a heat of reaction for the conversion of the feed stream to the product in the first reactor with the heated carrier stream.

2. The process of claim 1, wherein heating the cold carrier stream in the second reactor comprises:
combusting a combustion gas in the second reactor to create heat, and heating the carrier particles in the cold carrier stream with the heat.

3. The process of claim 2, wherein heating the carrier particles with the heat comprises directly contacting combustion products produced from combusting the combustion gas with the carrier particles in the cold carrier stream.

4. (canceled)

5. The process of claim 2, wherein the combustion gas comprises methane, natural gas, hydrogen, coal, methanol, ethanol, ethane, propane, butane, gasoline, kerosene, or naphtha.

6.-8. (canceled)

9. The process of claim 1, wherein heating the carrier particles in the second reactor comprises electrically heating the particles with resistive or inductive heating.

10. The process of claim 1, wherein at least a portion of the catalyst particles are entrained within the gas phase product leaving the first reactor, wherein the process further comprises:
separating a portion of the catalyst particles entrained in the gas phase product leaving the first reactor; and
returning at least a portion of the catalyst particles separated from the gas phase product to the first reactor.

11. (canceled)

12. The process of claim 1, further comprising:
feeding additional catalyst particles into the first reactor while the catalyst particles are entrained out of the first reactor.

13.-14. (canceled)

15. The process of claim 1, further comprising:
combining the cold carrier stream with an additional amount of the carrier particles, wherein heating the cold carrier stream in the second reactor comprises heating the additional amount of the carrier particles in the second reactor; and
preheating the additional amount of the carrier particles prior to combining the cold carrier stream with the additional amount of the carrier particles.

16. (canceled)

17. The process of claim 1, wherein heating the cold carrier stream in the second reactor comprises:
transporting the carrier particles in the cold carrier stream through the second reactor using a carrier gas, wherein the carrier gas stream comprises hydrogen, helium, neon, methane, nitrogen, carbon dioxide, argon, krypton, or combinations thereof; and
indirectly heating the carrier particles in the second reactor while transporting the carrier particles through the second reactor.

18.-19. (canceled)

20. The process of claim 1, wherein a reaction temperature in the first reactor is between 800 °C and 1300 °C, wherein the heated carrier stream is between 25 and 500 °C hotter than a reaction temperature in the first reactor, and wherein the cold carrier stream is between 0 and 300 °C cooler than a reaction temperature in the first reactor.

21.-23. (canceled)

24. The process of claim 1, wherein a mass flow rate of carrier particles in the heated carrier stream is between about 50 and about 5000 times a production rate of hydrogen by mass in the first reactor.

25. The process of claim 1, wherein the catalyst particles comprise Fe in its metallic, oxide, or carbide forms.

26. (canceled)

27. The process of claim 1, wherein the catalyst particles comprise W, V, Mo, Ti, Ni, Co, Ta, Zr, Cr, or Hf in their metallic, oxide, or carbide forms.

28. (canceled)

29. The process of claim 1, wherein the carrier particles comprise magnesium, aluminum, chromium, silicon, carbon, calcium, magnesia, alumina, chromia, silica, graphite, calcia, sand, gravel, or any combination thereof.

30. (canceled)

31. The process of claim 1, wherein the catalyst particles are formed from the same material as the carrier particles.

32. (canceled)

33. The process of claim 1, where the gas phase product comprises hydrogen and unreacted hydrocarbon, wherein the process further comprises:
separating the gas phase product into a first stream comprising predominantly hydrogen and a second stream comprising predominantly the unreacted hydrocarbon; and
recycling the second stream to an inlet of the first reactor.

34.-37. (canceled)

38. A multiphase reaction system comprising
a first reactor comprising catalyst particles and carrier particles disposed therein, wherein the first reactor is configured to receive a hydrocarbon feed and produce a product stream comprising hydrogen and solid carbon; and
a second reactor configured to receive the colder carrier particles from the first reactor, heat the carrier particles, and pass the heated carrier particles to the first reactor.

39. The system of claim 38, wherein the second reactor comprises a direct heat exchanger configured to directly contact a combusted gas and the carrier particles.

40. The system of claim 38, wherein the second reactor comprises an indirect heat exchanger configured to indirectly exchange heat between a heat source and the carrier particles.

41. The system of claim 38, further comprising a separator configured to receive a gas phase product from the first reactor and separate the gas phase product into a first stream comprising hydrogen and a second stream comprising an unreacted hydrocarbon.

42.-43. (canceled)

44. The system of claim 38, wherein the catalyst particles comprise Fe, W, V, Mo, Ti, Ni, Co, Ta, Zr, Cr, Hf in their metallic, oxide, or carbide forms.

45. (canceled)

46. The system of claim 38, wherein the carrier particles comprise magnesium, aluminum, chromium, silicon, carbon, calcium, magnesia, alumina, chromia, silica, graphite, calcia, sand, gravel, or any combination thereof.

47. (canceled)

48. The system of claim 38, wherein the catalyst particles are formed from the same as the carrier particles.

49. (canceled)
